(19) United States
(12) Patent Application Publication
(10) Pub. No.: US 2021/0211585 A1
(43) Pub. Date: Jul. 8, 2021

(54) IMAGE PROCESSING SYSTEM AND IMAGE PROCESSING METHOD

(71) Applicant: SZ DJI TECHNOLOGY CO., LTD., Shenzhen (CN)

(72) Inventors: Junping MA, Shenzhen (CN); Hui SUN, Shenzhen (CN); Zhanlei CHEN, Shenzhen (CN)

(21) Appl. No.: 17/212,691

(22) Filed: Mar. 25, 2021

Related U.S. Application Data
(63) Continuation of application No. PCT/CN2018/107609, filed on Sep. 26, 2018.

(51) Int. Cl. H04N 5/268; H04N 5/232

(52) U.S. Cl. CPC H04N 5/268; H04N 5/23229

(57) ABSTRACT

An image processing system includes an image sensor including an image output interface, an interface extension device including an extension input interface electrically coupled to the image output interface and at least two extension output interfaces, and at least two image processors coupled to the at least two extension output interfaces respectively. The image sensor is configured to detect an optical signal and convert the optical signal to a raw image signal, and output the raw image signal via the image output interface. The interface extension device is configured to receive the raw image signal from the image output interface via the extension input interface, and output target image signals to be processed corresponding to the raw image signal via the at least two extension output interfaces. The at least two image processors are configured to receive and process the target image signals.

### CROSS-REFERENCE TO RELATED APPLICATION

This application is a continuation of International Application No. PCT/CN2018/107609, filed Sep. 26, 2018, the entire content of which is incorporated herein by reference.

### TECHNICAL FIELD

The present disclosure relates to the field of image processing and, more particularly, to an image processing system and an image processing method.

### BACKGROUND

An image processing system plays an important role in a device such as a photographing device. An image processing system usually includes an image sensor and an image processor. The image sensor is configured to convert optical signals to electric signals and transmit the electric signals to the image processor. After receiving the electric signals from the image sensor, the image processor processes the electric signals, that is, processes the image signals. According to different application scenarios, the image processing system needs to process image signals differently to meet different needs.

An existing image processing system uses a single image processor to perform all image process tasks. Different image processors have different functions, and the functions of each image processor are usually limited. Correspondingly, the processing of image signals by a single image processor is also limited and cannot support higher-level functions. Therefore, the functions of the entire system are limited.

### SUMMARY

In accordance with the disclosure, there is provided an image processing system. The image processing system includes an image sensor including an image output interface, an interface extension device including an extension input interface electrically coupled to the image output interface and at least two extension output interfaces, and at least two image processors coupled to the at least two extension output interfaces respectively. The image sensor is configured to detect an optical signal and convert the optical signal to a raw image signal, and output the raw image signal via the image output interface. The interface extension device is configured to receive the raw image signal from the image output interface via the extension input interface, and output target image signals to be processed corresponding to the raw image signal via the at least two extension output interfaces. The at least two image processors are configured to receive and process the target image signals.

Also in accordance with the disclosure, there is provided an image processing method including an image sensor detecting an optical signal, converting the optical signal to a raw image signal, and transmitting the raw image signal to an interface extension device, the interface extension device transmitting, via at least two extension output interfaces of the interface extension device, target image signals to be processed corresponding to the raw image signal to at least two image processors, and the at least two image processors processing the target image signals.

### BRIEF DESCRIPTION OF THE DRAWINGS

The above and/or additional aspects and advantages of this disclosure will become obvious and easy to understand from the description of the embodiments in conjunction with the following drawings.

FIG. 1 is an exemplary image processing system consistent with various embodiments of the present disclosure.

FIG. 2 is an exemplary image processing method consistent with various embodiments of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” “front,” “back,” “lower,” “upper,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed. Further, “plurality of” means at least two.

The present disclosure provides an image processing system. The image processing system may include an image sensor, an interface extension device, and at least two image processors. The image sensor may be configured to detect optical signals and convert the optical signals to raw image signals. The image sensor may include an image output interface for outputting the raw image signals. The interface extension device may include an extension input interface and at least two extension output interfaces. The extension input interface may be electrically connected to the image output interface for receiving the raw image signals from the image output interface. The at least two extension output interfaces may be configured to output image signals to be processed corresponding to the raw image signals. Each one of the at least two image processors may be electrically connected to a corresponding one of the two extension output interfaces, for receiving the image signals to be processed and processing the image signals to be processed.

In the present disclosure, the image processing system may use the interface extension device to connect the at least two image processors to the image sensor. The at least two image processors may perform image processing respectively. Correspondingly, the quality of the image signals may be guaranteed. Further, image processors may be selected more flexibly, and the image processing may be not limited to the functions of one specific image processor of the at least two image processors. Advantages of different image processors may be used to achieve more advanced functions. Therefore, the functions of the image processing system may be richer and the performance may be improved.

The present disclosure also provides an image processing method. The method may include: using an image sensor to detect optical signals and convert the optical signals to raw image signals, which is transmitted to an interface extension device; using at least two extension output interfaces of the interface extension device to output image signals to be processed corresponding to the raw image signals to at least two image processors; and using the at least two image processors to process the image signals to be processed.

Embodiments of image processing system and image processing method will be described in detail below with reference to the drawings. In the case of no conflict, the following embodiments and features in the embodiments can be combined with each other.

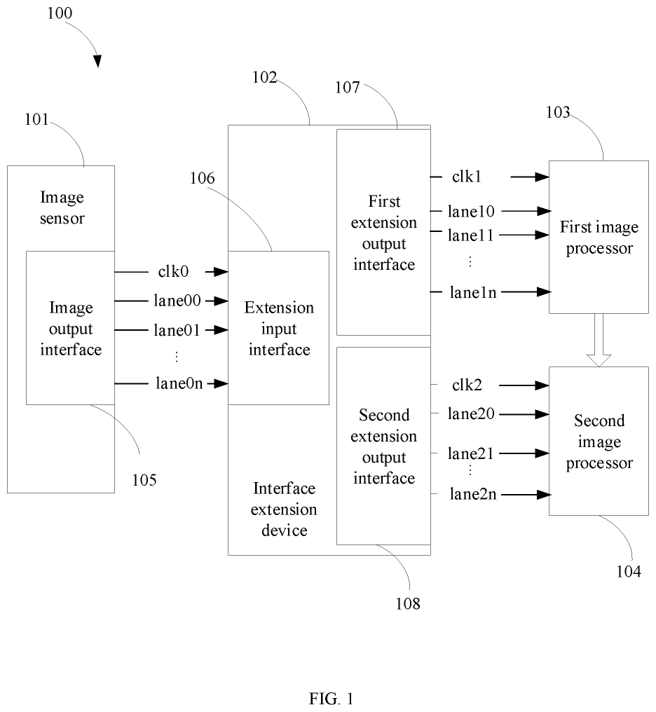

FIG. 1 is a block diagram of an example image process system 100 consistent with the disclosure. The image processing system 100 can be applied to a photographing device, such as a digital camera. In some other embodiments, the image processing system 100 may be applied to other suitable devices. The image processing system 100 includes an image sensor 101, an interface extension device 102, and at least two image processors including a first image processor 103 and a second image processor 104.

The image sensor 101 is configured to detect optical signals, and convert the optical signals to raw image signals. The image sensor 101 includes an image output interface 105 for outputting the raw image signals. The image sensor 101 may convert the optical signals to analog electric signals, and then convert the analog electric signals to digital signals. The raw image signals may be digital signals. In some embodiments, the image sensor 101 may include a complementary metal oxide semiconductor (CMOS) image sensor or a charge-coupled device (CCD) image sensor. The CMOS image sensor or CCD image sensor may support multi-channel output, and the bandwidth of each channel may be not less than 200 Mbps. The CMOS image sensor or CCD image sensor may have the characteristics of high resolution and high frame rate, and the amount of transmitted data may be large. In one embodiment, for example, the image sensor 101 may be a 4/3-inch CMOS image sensor or a 1-inch CMOS image sensor.

The image output interface 105 may include a multi-channel data interface. For example, in one embodiment, the image output interface 105 may be a 9-channel data interface. One channel may output clock signals clk0, and other eight channels may output image data lane00-lane0n where n is a natural number. In one embodiment, n may be 7. The embodiments here are used as examples to illustrate the present disclosure and should not limit the scopes of the present disclosure. In some other embodiments, the image output interface 105 may be a data interface with a single-digit number of channels. In some embodiments, the bandwidth of a single channel of the data interface may be not less than 200 Mbps. In some other embodiments, the bandwidth of a single channel of the data interface may reach more than 300 Gbps. In some other embodiments, the bandwidth of a single channel of the data interface may reach more than 1 Gbps. The data interface may be a high-speed data interface, which can transmit the raw image signals of the high-end image sensor at a high speed. In one embodiment, the data interface may include a serial data interface. In one embodiment, the serial data interface may include a low voltage differential signal (LVDS) interface or a mobile industry processor interface (MIPI). In other embodiments, the serial data interface may include other high-speed serial data interfaces.

The interface extension device 102 includes an extension input interface 106 and at least two extension output interfaces. In one embodiment, the interface extension device 102 includes two extension output interfaces comprising a first extension output interface 107 and a second extension output interface 108. The extension input interface 106 is electrically connected to the image output interface 105 for receiving the raw image signals from the image output interface 105. The first extension output interface 107 and the second extension output interface 108 are configured to output image signals to be processed corresponding to the raw image signals. An image signal to be processed is also referred to as a “target image signal.”

The extension input interface 106 may match the image output interface 105. The image sensor 101 may output the raw image signals through the image output interface 105. The interface extension device 102 may receive the raw image signals through the extension input interface 106. In one embodiment, the extension input interface 106 may be a multi-channel data interface. A bandwidth of a single channel of the extension input interface 106 may be consistent with or higher than the bandwidth of a single channel of the image output interface 105. The extension input interface 106 may be a high-speed data interface, satisfying data transmission of the high-end image sensor 101. In one embodiment, the extension input interface 106 may be a serial data interface.

The interface extension device 102 may be configured to receive the clock signals from the image sensor 101, and also adjust the phase relationship between the raw image signals and the clock signals when receiving the raw image signals to make a phase difference between each channel data of the raw image signals and the clock signals roughly same. Correspondingly, the stability of data receiving may be improved. One channel of the extension input interface 106 may be configured to receive the clock signals clk0, and other channels may be configured to receive multi-channel data lane00-lane0n of the raw image signals.

In the embodiment illustrated in FIG. 1, the interface extension device 102 includes two extension output interfaces, that is, the first extension output interface 107 and the second extension output interface 108. The first extension output interface 107 and the second extension output interface 108 are configured to output the image signals to be processed corresponding to the raw image signals separately. In some other embodiments, the interface extension device 102 may include three or more sets of extension output interfaces. Further, each of the first extension output interface 107 and the second extension output interface 108 may include multiple channels and a number of the channels may be same as the number of the channels of the image output interface 105 and the number of the channels of the extension input interface 106.

In some embodiments, when outputting the image signals to be processed, the interface extension device 102 may be configured to adjust a phase relationship between the image signals to be processed and the clock signals, to make a phase difference between each channel data of the image signals to be processed and the clock signals roughly same. Stability of data outputting may be improved. In the embodiment shown in FIG. 1, one channel of the first extension output interface 107 outputs the clock signals clk1, and other channels of the first extension output interface 107 output data lane10-lane1n of different channels of the image signals to be processed. One channel of the second extension output interface 108 outputs the clock signals clk2, and other channels of the second extension output interface 108 output data lane20-lane2n of different channels of the image signals to be processed.

In one embodiment, the interface extension device 102 may use the at least two extension output interfaces to output the image signals to be processed corresponding to the raw image signals. The interface extension device 102 may separate the raw image signals into two groups for output. For example, in one embodiment, the image signals to be processed lane10-lane1n from the first extension output interface 107 and the image signals to be processed lane20-lane2n from the second extension output interface 108 may both be same as the raw image signals lane00-lane0n.

In another embodiment, the image signals to be processed may include first image signals to be processed (“first target image signals”). The interface extension device 102 may be configured to process the raw image signals to obtain the first image signals to be processed. The interface extension device 102 may use at least one of the at least two extension output interfaces, for example, the first extension output interface 107 and/or the second extension output interface 108, to output the first image signals to be processed. The interface extension device 102 may process the raw image signals and then output. In some embodiments, the process that the interface extension device 102 performs on the raw image signals may include processing a number of pixels and/or pixel width of the raw image signals. In one embodiment, processing the number of pixels may include adjusting pixel resolution, for example, adjusting the pixel resolution from 4k resolution (4096×2160) to 1080p resolution (1920×1080). In some other embodiments, the interface extension device 102 may perform other processes on the raw image signals.

In one embodiment, the at least two extension output interfaces of the interface extension device 102 may all output the first image signals to be processed. In another embodiment, a portion of the at least two extension output interfaces of the interface extension device 102 may output the first image signals to be processed, and another portion of the at least two extension output interfaces of the interface extension device 102 may output image signals different from the first image signals to be processed. The image signals to be processed may include second image signals to be processed (“second target image signals”), and the second image signals to be processed may be different from the first image signals to be processed. Correspondingly, the interface extension device 102 may use at least another extension output interface of the at least two extension output interfaces to output the second image signals to be processed. For example, in the embodiment shown in FIG. 1, the first extension output interface 107 is configured to output the first image signals to be processed lane10-lane1n, and the second extension output interface 108 is configured to output the second image signals to be processed lane20-lane2n. In some other embodiments, two or more extension output interfaces of the at least two extension output interfaces may be configured to output the first image signals to be processed, and/or other two or more extension output interfaces of the at least two extension output interfaces may be configured to output the second image signals to be processed. The interface extension device 102 may use different extension output interfaces of the at least two extension output interfaces to output different image signals to be processed to the corresponding image processors, for example, the first image processor 103 and the second image processor 104 in FIG. 1. Correspondingly, requirements of the different image processors on the image data may be satisfied.

In one embodiment, the second image signals to be processed may be same as the raw image signals. In other embodiments, the second image signals to be processed may be different from the raw image signals. The interface extension device 102 may process the raw image signals to generate the second image signals to be processed. The interface extension device 102 may perform different processes on the raw image signals to generate the different first image signals to be processed and second image signals to be processed. In some embodiments, the interface extension device 102 may be configured to output other image signals to be processed different from the first image signals to be processed and the second image signals to be processed.

In one embodiment, the interface extension device 102 may include a programmable logic device, and can be programmed according to different application and requirements. Correspondingly, design may be convenient and flexible. In some embodiments, the programmable logic device may include a field-programmable gate array (FPGA). The bandwidth of a high-speed serial port of an FPGA can be more than 1 Gbps, and some can even reach 1.5 Gbps, which can meet the needs of high-speed image data transmission and many high-end image sensors and support many image processors. Correspondingly, device selection can be more flexible. In some other embodiments, the programmable logic device may include a complex programmable logic device (CPLD), and can match many high-end image sensors and support many image processors.

Suitable programmable logic devices may be selected according to the number of channels of the image output interface 105 of the image sensor 101 and a number of the image processors. A number of channels of the programmable logic device may be equal to a sum of the number of channels of the image output interface 105 and the number of channels of the at least two extension output interfaces. For example, in one embodiment, the image sensor 101 may output a channel of LVDS clock data and eight channels of LVDS image data, i.e., a total of nine channels of LVDS data. If one interface of the programmable logic device is configured to receive the data from the image sensor 101 and two interfaces of the programmable logic device are configured to output the image data to be processed, the programmable logic device may need to have three interfaces and totally 27 LVDS channels. Correspondingly, a programmable logic device capable of supporting 27 LVDS channels may be selected. The above embodiment is used as an example to illustrate the present disclosure and does not limit the scope of the present disclosure.

In another embodiment, the interface extension device 102 may include an application specific integrated circuit (ASIC) chip. The ASIC chip may be customized according to actual needs.

Each of the at least two image processors may be electrically connected to a corresponding one of the at least two extension output interfaces, for receiving and processing the image signals to be processed. In the embodiment shown in FIG. 1, the image processing system 100 includes two image processors, that is, the first image processor 103 and the second image processor 104. The first image processor 103 is connected to the first extension output interface 107, and the second image processor 104 is connected to the second extension output interface 108. In some other embodiments, the image processing system 100 may include three or more image processors connected to corresponding extension output interfaces of the at least two the extension output interfaces.

Correspondingly, the image processing system 100 may use the interface extension device 102 to connect the at least two image processors to the image sensor 101. Effective transmission of the image data may be achieved, especially for high-end image sensors. Further, the at least two image processors may perform image processing separately. In design the image processors may be selected more flexibly. The system may be not limited to functions of one specific image processor and may use advantages of different image processors.

Correspondingly, high performance may be achieved in functions of each image processor, to achieve more advanced functions. The functions of the image processing system may be richer and the performance may be more powerful.

In one embodiment, the at least two image processors may include the first image processor 103 and the second image processor 104. The second image processor 104 may perform processing on the image signals to be processed at least partly differently from the first image processor 103. The first image processor 103 and the second image processor 104 may perform completely or partially different processing on the image signal to be processed to obtain different processed images. The image signals to be processed received by the first image processor 103 and the second image processor 104 may be the same or different.

In one embodiment, the first image processor 103 and the second image processor 104 may include different chips. Different chips may focus on different processing and different functions may be realized through different chips. In another embodiment, the first image processor 103 and the second image processor 104 may include the same chips, and the data can be processed differently through the same chip to realize different functions and reduce the workload of a single chip, to improve computing speed.

In one embodiment, the at least two image processors may be configured to perform at least one of image signal processing, image display, image compression, image storage, or image transmission, on the image signal to be processed. For example, in one embodiment, the first image processor 103 and the second image processor 104 performing different processing on the image signal to be processed may include: performing different types of processing on the image signal to be processed, for example, two different types of processing including image signal processing or image display, and/or, performing processing on the image signal to be processed is processed in the same type but in different ways, for example, image compression processing of different standards.

In one embodiment, the image signal processing may include first image signal processing, and the first image processor 103 may be configured to perform the first image signal processing on the image signal to be processed. For example, processing of the number of pixels, processing of pixel bit width, image transformation, image enhancement and restoration, image segmentation, image description and/or image recognition can be performed on the image signal to be processed.

In one embodiment, the second image processor 104 may be configured to perform first image compression on the image signal to be processed. Correspondingly, the first image processor 103 can focus on image signal processing, and the second image processor 104 can focus on image compression.

In one embodiment, the first image processor 103 may be configured to perform first image signal processing on the image signal to be processed, and then further perform second image compression on the image signal to be processed. The second image compression may be different from the first image compression. The first image processor 103 can also compress images. The first image processor 103 and the second image processor 104 may perform image compression of different standards to obtain different compressed images. In one embodiment, the image quality of the image obtained by the second image compression may be higher than the image quality of the image obtained by the first image compression. For example, the first image processor 103 may perform H.264 standard image compression, and the second image processor 104 may perform JPEG2000 standard image compression, or H265 standard image compression with higher image quality, to achieve higher-level image compression functions.

In another embodiment, the second image processor 104 may be configured to perform the first image storage of the image signal to be processed. Correspondingly, the first image processor 103 can focus on image signal processing, and the second image processor 104 can focus on image storage.

In one embodiment, the first image processor 103 may be configured to perform the first image signal processing on the image signal to be processed, and may be further configured to perform the second image storage on the image signal to be processed. The first image storage may be different from the second image storage. The first image processor 103 can also store images, and the first image processor 103 and the second image processor 104 may store images with different storage capacities. In one embodiment, the storage capacity of the second image processor 104 may be greater than the storage capacity of the first image processor 103. The second image processor 104 may perform professional image storage, and may support a higher storage bandwidth, to store images with higher image quality. For example, the first image processor 103 may store images through an SD card, and the second image processor 104 may stores images through a storage device with a storage bandwidth and/or storage capacity larger than the SD card, such as a solid-state drive (SSD) or a universal flash storage (UFS).

In another embodiment, the second image processor 104 may be configured to perform the second image signal processing, and the second image signal processing performed by the second image processor 104 may be different from the first image signal processing performed by the first image processor 103. The algorithm of the first image signal processing may be different from the algorithm of the second image signal processing, and different images may be obtained. The second image processor 104 can perform simple image signal processing with respect to the first image processor 103. For example, the first image signal processing may include image conversion, image enhancement and restoration, image segmentation, image description, or image recognition processing on the image signal to be processed. The second image signal processing may include processing of the number of pixels and or the pixel width of the image signal to be processed. For example, the first image processor 103 may perform image recognition including portrait recognition to complete subsequent image signal processing, and the second image processor 104 may perform image display and/or image storage as a typical digital camera. For description purposes only, the above embodiments are used as examples to illustrate the present disclosure and do not limit the scopes of the present disclosure. In various embodiments, the first image processor 103 and the second image processor 104 may perform different image signal processing according to actual needs.

In one embodiment, the second image processor 104 may perform at least two functions of image compression, image storage, or second image signal processing. In one embodiment, the second image processor 104 may include a chip dedicated to image compression, to perform the second image signal processing on the image signal to be processed and compress the processed image. In another embodiment, the second image processor 104 may include a chip dedicated to image storage, to perform the second image signal processing on the image signal to be processed and store the processed image. In some other embodiments, the second image processor 104 may perform the second image signal processing on the image signal to be processed, and compress and store the processed image.

In some embodiments, the first image processor 103 may also be used for image display processing, to process the image signals into data suitable for display, for example, high-definition multimedia interface (HDMI) image display processing. In some embodiments, the first image processor 103 may also be used for image transmission processing. The image transmission may include wireless image transmission, and the first image processor 103 may be used to wirelessly send the processed image to other devices. In some other embodiments, the first image processor 103 and/or the second image processor 104 can also perform other image processing. For example, the second image processor 104 can be used for image display and/or image transmission.

In one embodiment, the at least two image processors may be communicatively coupled to each other. For example, in one embodiment, the first image processor 103 and the second image processor 104 may communicate and work together. For example, the image signal processed by the first image processor 103 may be sent to the second image processor 104, and the second image processor 104 may compress and store the image signal. In this way, more and more advanced functions can be realized to meet different needs and make the design more flexible. In one embodiment, the at least two image processors may be wiredly connected. In an embodiment, the first image processor 103 and the second image processor 104 may be communicatively coupled to each other through a universal asynchronous receiver-transmitter (UART) interface, an inter-integrated circuit (I2C) interface, or a serial peripheral interface (SPI). In another embodiment, the at least two image processors may be connected wirelessly.

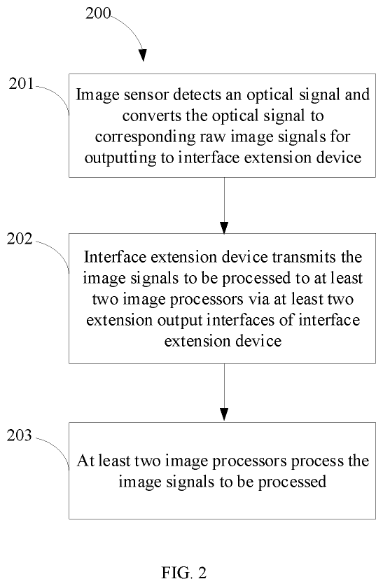

The present disclosure also provides an image processing method. FIG. 2 is a flow chart of an example image processing method 200 consistent with the disclosure. The image processing method 200 may be performed by an image processing system consistent with the disclosure, such as the example image processing system shown in FIG. 1. As shown in FIG. 2, at 201, optical signals are detected and converted to corresponding raw image signals by an image sensor, and the raw image signals are transmitted to an interface extension device. The image sensor may be the image sensor 101 in FIG. 1. The interface extension device may be the interface extension device 102 in FIG. 1. In one embodiment, the image sensor may include a CMOS image sensor or a CCD image sensor.

At 202, image signals to be processed corresponding to the raw image signals are transmitted to at least two image processors through at least two extension output interfaces of the interface extension device. The at least two image processors may be the first image processor 103 and the second image processor 104 in FIG. 1. At 203, the at least two image processors perform processing on the image signals to be processed.

In the present disclosure, the image processing method may use the interface extension device to transmit the image signals to be processed corresponding to the raw image signals from the image sensor to the at least two image processors for processing. The different image processors may be configured to perform different processing on the image signals to be processed. Correspondingly, in design, the image processors can be selected more flexibly while ensuring the quality of the image signals. The image processing may be not limited to the functions of a certain image processor, and can use the advantages of different image processors to achieve more and more advanced functions. The function can be richer and the performance may be more powerful.

In one embodiment, process 201 includes: outputting the raw image signals to the interface expansion device through a multi-channel data interface of the image sensor. In one embodiment, the bandwidth of a single channel of the data interface may be not less than 200 Mbps. In one embodiment, the data interface may include a serial data interface. In one embodiment, the serial data interface may include an LVDS interface or MIPI interface.

In one embodiment, the image signals to be processed may be the same as the raw image signals. In another embodiment, the image signals to be processed may include first image signal to be processed. Process 202 may include: processing the raw image signals through the interface expansion device to obtain the first image signals to be processed; and outputting the first image signal to be processed to at least one image processor through at least one extension output interface of the at least two extension output interfaces. In one embodiment, the raw image signals may be processed by changing the number of pixels and/or the pixel bit width through the interface expansion device. In one embodiment, the image signals to be processed may include second image signals to be processed. Process 202 may include: sending the second image signals to be processed to at least another image processor through at least another extended output interface.

In one embodiment, the interface expansion device may include a programmable logic device. In one embodiment, the programmable logic device may include an FPGA device or a CPLD device. In another embodiment, the interface expansion device may include an ASIC chip.

In one embodiment, the image processing method may further include: receiving clock signals from the image sensor through the interface extension device, and when receiving the raw image signals, adjusting a phase relationship between the raw image signals and the clock signals. In one embodiment, through the interface extension device, when the image signal to be processed is output, the phase relationship between the image signals to be processed and the clock signals may be adjusted.

In one embodiment, the at least two image processors may include a first image processor and a second image processor. Process 203 may include: processing the image signals to be processed by the first image processor and the second image processor respectively. The processing of the image signals to be processed by the first image processor may be at least partly different from that of the image signals to be processed by the second image processor. In one embodiment, the first image processor and the second image processor may include different chips. In another embodiment, the first image processor and the second image processor may include same chips.

In one embodiment, process 203 may include: performing at least one of image signal processing, image display, image compression, storage, or image transmission on the image signals to be processed. In one embodiment, process 203 may include: performing the first image signal processing on the image signals to be processed by the first image processor. In one embodiment, process 203 may include: performing the first image compression on the image signals to be processed by the second image processor.

In one embodiment, process 203 may include: after performing the first image signal processing on the image signals to be processed, using the first image processor to perform the second image compression on the image signals to be processed. The second image compression may be different from the first image compression. In one embodiment, the image quality of the image obtained by the second image compression may be higher than the image quality of the image obtained by the first image compression.

In one embodiment, process 203 may include: performing the first image storage on the image signals to be processed by the second image processor. In one embodiment, process 203 may include: after performing the first image signal processing on the image signals to be processed, using the first image processor further to perform the second image storage on the image signals to be processed. The first image storage may be different from the second image storage. In one embodiment, the storage capacity of the second image processor may be greater than the storage capacity of the first image processor.

In one embodiment, process 203 may include: performing the second image processing by the second image processor. The second image processing may be different from the first image processing.

The different respects of the image processing methods can be referred to the above embodiments of the image processing system.

In one embodiment, the image processing method 200 may further include: performing communication between the at least two image processors. In one embodiment, communication may be performed between the at least two image processors in a wired manner. In some embodiments, communication may be performed between the at least two image processors through a UART interface, an I2C interface or an SPI interface. In some other embodiments, communication may be performed between at least two image processors wirelessly.

In this disclosure, terms such as “first” and “second” are only used to distinguish one entity or operation from another entity or operation, and do not necessarily require or imply existence of any such relationship or sequence among these entities or operations. The terms “include,” “comprise” or any other variants thereof are intended to cover non-exclusive inclusion, so that a process, method, article, or device including a series of elements not only includes those elements, but also includes other elements not explicitly listed, or also includes elements inherent to such process, method, article, or device. If there are no more restrictions, the element associated with “including a . . . ” does not exclude the existence of other identical elements in the process, method, article, or device that includes the element.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. An image processing system comprising:
an image sensor configured to detect an optical signal and convert the optical signal to a raw image signal, the image sensor including an image output interface configured to output the raw image signal;
an interface extension device including:
an extension input interface electrically coupled to the image output interface and configured to receive the raw image signal from the image output interface; and
at least two extension output interfaces configured to output target image signals to be processed corresponding to the raw image signal; and
at least two image processors coupled to the at least two extension output interfaces respectively, and configured to receive and process the target image signals.

2. The image processing system according to claim 1, wherein the interface extension device is configured to output the target image signals same as the raw image signal via the at least two extension output interfaces.

3. The image processing system according to claim 1, wherein the interface extension device is configured to:
process the raw image signal to obtain one of the target image signals; and
output the one of the target image signals via at least one of the at least two extension output interfaces.

4. The image processing system according to claim 3, wherein the interface extension device is configured to perform processing on at least one of a number of pixels or a pixel width of the raw image signal.

5. The image processing system according to claim 3, wherein:
the one of the target image signals is a first target image signal;
the target image signals further include a second target image signal different from the first image signal to be processed; and
the interface extension device is further configured to output the second target image signal through at least another one of the at least two extension output interfaces.

6. The image processing system according to claim 1, wherein the image output interface includes a multi-channel data interface.

7. The image processing system according to claim 6, wherein a bandwidth of each channel of the data interface is not less than 200 Mbps.

8. The image processing system according to claim 6, wherein the data interface includes a serial data interface.

9. The image processing system according to claim 1, wherein the interface extension device includes a programmable logic device.

10. The image processing system according to claim 1, wherein the interface extension device includes an application specific integrated circuit (ASIC) chip.

11. The image processing system according to claim 1, wherein:
the at least two image processors include a first image processor and a second image processor; and
processing on the target image signals by the second image processor is at least partially different from processing on the target image signals by the first image processor.

12. The image processing system according to claim 11, wherein the at least two image processors are configured to perform at least one of image signal processing, image display, image compression, image storage, or image transmission on the target image signals.

13. The image processing system according to claim 12, wherein the first image processor is configured to perform image signal processing on the target image signals.

14. The image processing system according to claim 13, wherein:
the image signal processing performed by the first image processor on the target image signals is first image signal processing;
the second image processor is configured to perform second image signal processing on the target image signals; and
the second image signal processing is different from the first image signal processing.

15. The image processing system according to claim 12, wherein the second image processor is configured to perform image compression on the target image signals.

16. The image processing system according to claim 12, wherein the second image processor is configured to perform image storage on the target image signals.

17. The image processing system according to claim 1, wherein the at least two image processors are communicatively coupled to each other.

18. The image processing system according to claim 1, wherein the interface extension device is further configured to:
receive a clock signal from the image sensor; and
adjust a phase relationship between the raw image signal and the clock signal while receiving the raw image signal.

19. The image processing system according to claim 18, wherein the interface extension device is further configured to adjust a phase relationship between the target image signals and the clock signal while outputting the target image signals.

20. An image processing method comprising:
detecting, by an image sensor, an optical signal;
converting, by the image sensor, the optical signal to a raw image signal;
transmitting, by the image sensor, the raw image signal to an interface extension device;
transmitting, by the interface extension device via at least two extension output interfaces of the interface extension device, target image signals to be processed corresponding to the raw image signal to at least two image processors; and
processing, by the at least two image processors, the target image signals.
